(19) United States
(12) Patent Application Publication
(10) Pub. No.: US 2010/0084870 A1
(43) Pub. Date: Apr. 8, 2010

(54) Floating electrical generator for aqueducts and slow moving waterways

(76) Inventor: Frank Burcik, Lakewood, CO (US)

Correspondence Address: BARBER LEGAL, P.O. BOX 16220, GOLDEN, CO, 80402-6004, US

(21) Appl. No.: 12/287,015

(22) Filed: Oct. 3, 2008

(51) Int. Cl. F03B 13/00

(52) U.S. Cl. 290/54

(57) ABSTRACT

A power generator has a large paddle wheel having a width dimensioned to fit within an aqueduct/canal/slow-moving waterway. The paddle wheel has a plurality of radially projecting paddles which rotate even is slow current flow. Floats allow the paddle wheel to float on the surface of the water. A flexible or jointed drive shaft mechanism allows rotation of the paddle wheel to be transmitted to an electricity generator in an installation on land even if the axis of the paddle wheel and the axis of the electricity generator are not the same. The linkage (the drive shaft mechanism) in particular allows the transmission of rotary mechanical power even if the water level in the aqueduct raises the paddle wheel axis higher or lower than the axis of the electrical generator.

### CROSS-REFERENCE TO RELATED APPLICATIONS

The application claims the priority and benefit of copending U.S. Provisional Patent Application No. 60/997,454 filed Oct. 2, 2007 in the name of the same inventor, Frank Burcik and also entitled METHOD AND ELECTRICAL GENERATOR FOR AQUEDUCTS AND SLOW MOVING WATERWAYS, the entire disclosure of which in incorporated herein by this reference.

### STATEMENT REGARDING FEDERALLY FUNDED RESEARCH

This invention was not made under contract with an agency of the US Government, nor by any agency of the US Government.

### BACKGROUND OF THE INVENTION

Power generation is rapidly becoming a central issue in the US and worldwide as inexpensive sources of energy become scarcer and increasing concerns about global environmental impact further constrain choices. There are a fairly small number of energy generation technologies which can provide significant amounts of energy, especially electrical energy, and all have fundamental limitations. Solar energy for electrical generation requires sunlight, limiting generation to the daylight hours. Hydrocarbons for electricity generation suffer from price fluctuations and slowly dwindling availability, for example, as of July of 2008, crude oil costs $147 per barrel. Nuclear energy leads to waste disposal issues which are solvable but nuclear energy is so unpopular that it limits the acceptance of nuclear energy. Coal is fundamentally dirty to mine and burn: great numbers of coal miners suffer from “Black Lung” disease from being around coal dust.

Hydroelectric power in particular is generally considered to be reaching some sort of saturation point as the remaining locations available for construction of traditional hydroelectric dams become steadily “taken”. As a result, alternative energy sources such as tidal energy, wave energy and the like are now being explored, however, hydroelectric power in landlocked areas still has large unused potential.

The US has numerous aqueducts, canals and other slow moving waterways which are ordinarily deprecated as sources of hydroelectricity. In normal hydroelectric generations systems a high “head” (vertical drop) of water is desirable in order to generate pressure used to run enormous and expensive turbines, which in turn drive electrical generators. The slow rate of water motion of aqueducts and other slow water ways is regarded as a smaller disadvantage, but the tendency of aqueducts and the like follow contours of the ground in order to maintain a smooth gradient (typically one inch in about four feet) is a more important disadvantage: no “head” is developed.

In general, development of a large “fall” or pressure drop is regarded as necessary in order to generate meaningful amounts of energy using turbines hooked to generators. Since aqueducts and canals are specifically laid out with smooth contours and low gradients, energy generation from aqueducts carrying residential or agricultural water is contrary to common sense. However, the present invention teaches that in fact very large amounts of energy are available even in slow moving waterways.

The largest and most expensive single aqueduct system built in the US is the Central Arizona Project. The backbone of the aqueduct covers 336 miles (˜540 km.) from Lake Havasu to the Tucson area and delivers 1.5 million acre-feet of water in an average year. It is worth noting that the top of the canal dykes are 80 feet (˜26 m.) wide in most places, with a typical water depth of 16.5 feet (˜5.5 m.) However, at least one section some miles long is considerably wider.

Numerous other US canals and aqueducts exist, for example, the California Aqueduct is 444 miles (˜700 km.) long, with a width at the widest section of 110 feet (˜35 m.) and a typical water depth of 9 m.

One partial list of US irrigation aqueducts includes: All-American Canal, Coachella Canal, Colorado River Aqueduct, Contra Costa Canal, Hillsboro Canal, Inter-California Canal, Los Angeles Aqueduct, Miami Canal, St. Lucie Canal, Tamiami Canal, West Palm Beach Canal, El Paso Canal, Franklin Canal, American Canal, and Riverside Canal, however, many more irrigation canals exist, and a large number of transportation canals also exist as well.

Globally, the number of irrigation aqueducts and canals increases dramatically. For example, the Indira Gandhi/Rajasthan Canal runs 400 miles and irrigates 1.5 million acres of farmland, while in Pakistan the Chashma-Jhelum link joins the Indus and Jhelum Rivers and discharges 615 cubic meters of water per second. It will be appreciated that aqueduct and canal construction has been going on for thousands of years and is amenable to low tech construction techniques. This making it a desirable economic activity world-wide, as it may be contemplated by governments having more labor than capital or technology.

While some aqueducts are located far from residential or industrial areas, other aqueducts are located near cities, in fact, many aqueducts are even located in cities.

It would be preferable to provide a method of generating electricity from the long runs (often hundreds of miles) of steadily flowing water present in aqueducts and canals worldwide.

### SUMMARY OF THE INVENTION

### General Summary

The present invention teaches a floating paddle wheel placed in the calm and steady flow of water in aqueducts and canals, as well as other slow moving waterways.

The power generator has a large paddle wheel having a width dimensioned to fit within an aqueduct/canal/slow-moving waterway, and having a plurality of radially projecting paddles, typically 5 or 6 or more, which are free to rotate even is slow current flow. For example, in an aqueduct section 100 feet wide at the normal water level of the aqueduct, the paddle wheel may easily be 80 feet wide and may project several feet or meters into the water, thus providing an immense area against which slow moving water may push.

Floats allow the paddle wheel to float on the surface of the water. The floats may be pontoon style floats, or may be integral to the paddle wheel (thus it may by itself be buoyant), or the paddle wheel may be mechanically supported.

A flexible or jointed drive shaft mechanism allows rotation of the paddle wheel to be transmitted to an electricity generator in an installation on land even if the axis of the paddle wheel and the axis of the electricity generator are not the same. In particular, the flexible linkage (the drive shaft mechanism) allows the transmission of rotary mechanical power even if the water level in the aqueduct raises the paddle wheel axis higher or lower than the axis of the electrical generator: water levels in aqueducts and canals and slow moving waterways are typically adjusted from time to time based upon availability of water, wild-life concerns, sporting needs, demand and so on.

### Summary in Reference to Claims

It is therefore a first aspect, advantage, objective and embodiment of the present invention to provide an electrical power generator comprising:
a section of aqueduct carrying slow moving agricultural or residential water, the section of aqueduct having a width and a depth and at least one bank;
a rotatable floating body having an axis and a length, the rotatable floating body disposed afloat on such slow moving agricultural or residential water and disposed at least partially within such aqueduct;
a plurality of paddles projecting from the rotatable floating body orthogonal to the axis and projecting into the slow moving agricultural or residential water, the paddles having a width measured orthogonal to the axis and a length measured parallel to the axis;
an electrical generator, the electrical generator having a generator shaft;
a power transmission train having a first end connected to the rotatable floating body whereby the power transmission train rotates about the axis of the rotatable floating body when the rotatable floating body rotates, the power transmission train having a second end connected to the generator shaft and operatively connected thereto whereby motion of the slow moving agricultural or residential water impels rotation of the paddles and thus the rotatable floating body, and further whereby rotation of the rotatable floating body impels rotation of the power transmission train thereby impelling rotation of the electrical generator shaft;
the body length and paddle length being less than such waterway width; and
the paddle width being less than such waterway depth.

It is therefore another aspect, advantage, objective and embodiment of the present invention to provide an electrical power generator wherein:
the length of the paddles is approximately the width of the aqueduct.

It is therefore another aspect, advantage, objective and embodiment of the present invention to provide an electrical power generator wherein:
the power transmission train is flexible.

It is therefore another aspect, advantage, objective and embodiment of the present invention to provide an electrical power generator wherein:
the electrical generator is disposed upon the at least one bank of the aqueduct.

It is therefore another aspect, advantage, objective and embodiment of the present invention to provide an electrical power generator further comprising:
a non-rotatable floating body part.

It is therefore another aspect, advantage, objective and embodiment of the present invention to provide an electrical power generator wherein:
the electrical generator is disposed upon the non-rotatable floating body part.

It is therefore another aspect, advantage, objective and embodiment of the present invention to provide an electrical power generator wherein the non-rotatable floating body part further comprises:
at least one pontoon disposed at a first end of the rotatable floating body.

It is therefore another aspect, advantage, objective and embodiment of the present invention to provide a method of generating electrical power, the method comprising:
disposing upon a section of aqueduct carrying slow moving agricultural or residential water, the section of aqueduct having a width and a depth and at least one bank, at least one rotatable floating body having an axis and a length, the rotatable floating body disposed afloat on such slow moving agricultural or residential water and disposed at least partially within such aqueduct, the rotatable floating body having a plurality of paddles projecting from the rotatable floating body orthogonal to the axis and projecting into the slow moving agricultural or residential water, the paddles having a width measured orthogonal to the axis and a length measured parallel to the axis, the body length and paddle length being less than such waterway width, the paddle width being less than such waterway depth;
providing an electrical generator, the electrical generator having a generator shaft;
providing a power transmission train having a first end connected to the rotatable floating body whereby the power transmission train rotates about the axis of the rotatable floating body when the rotatable floating body rotates, the power transmission train having a second end connected to the generator shaft and operatively connected thereto whereby motion of the slow moving agricultural or residential water impels rotation of the paddles and thus the rotatable floating body, and further whereby rotation of the rotatable floating body impels rotation of the power transmission train thereby impelling rotation of the electrical generator shaft;
allowing the slow moving agricultural or residential water to rotate the rotatable floating body.

It is therefore another aspect, advantage, objective and embodiment of the present invention to provide a method of generating electrical power wherein:
the length of the paddles is approximately the width of the aqueduct.

It is therefore another aspect, advantage, objective and embodiment of the present invention to provide a method of generating electrical power wherein:
the power transmission train is flexible.

It is therefore another aspect, advantage, objective and embodiment of the present invention to provide a method of generating electrical power wherein:
the electrical generator is disposed upon the at least one bank of the aqueduct.

It is therefore another aspect, advantage, objective and embodiment of the present invention to provide a method of generating electrical power further comprising:
a non-rotatable floating body part.

It is therefore another aspect, advantage, objective and embodiment of the present invention to provide a method of generating electrical power wherein:
the electrical generator is disposed upon the non-rotatable floating body part.

It is therefore another aspect, advantage, objective and embodiment of the present invention to provide a method of generating electrical power wherein the non-rotatable floating body part further comprises:
at least one pontoon disposed at a first end of the rotatable floating body.

### BRIEF DESCRIPTION OF THE DRAWINGS

FIG. 1 is an orthogonal partially transparent view of a paddle wheel of the first embodiment of the invention.

FIG. 2 is a partially transparent side view of a float and wheel portion of the first embodiment of the invention in use in a waterway.

FIG. 3 is a cross-sectional end view of the first embodiment of the invention in use in a waterway, showing power transmission and electricity generation structures.

FIG. 4 is a planform top view of a section of aqueduct with multiple electrical energy generation devices of the invention shown in use.

### INDEX TO REFERENCE NUMERALS

Body 102
Paddle 104
Paddlewheel axis 106
Paddle support 108
Body 202
Paddle 204
Paddlewheel axle 206
End support 208
Bearing and support assembly 210
Pontoon/float 212
Water/waterway 214
Flow direction arrow 216
Rotation direction arrow 218
Body 302
Paddle 304
Paddlewheel axle 306
Pontoon/float 312
Water/waterway 314
Aqueduct liner 316
Rotary flexible power transmission 318
Generator drive shaft 320
Electricity generator 322
Embankment/bank 324
Electricity generation devices 450
Electrical transmission system 452
Waterway 454
Interruption of waterway 456
Electrical generator 458

### DETAILED DESCRIPTION

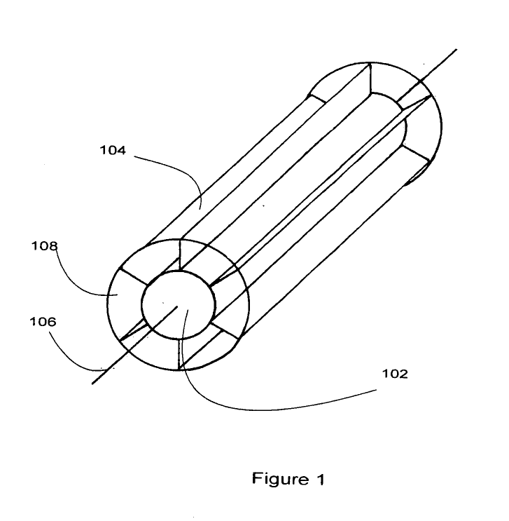

FIG. 1 is an orthogonal partially transparent view of a paddle wheel of the first embodiment of the invention. A central body may in embodiments be reduced to a central axis of rotation, however, in the presently preferred embodiment and best mode now contemplated, a physical body 102 is generally cylindrical. Other shapes may be used, either regular or irregular. In embodiments, the body may be buoyant and pontoons and other external floats may be eliminated.

The body may be made of a strong material, one which ages well during repeated cycles of exposure to air and water. Metal, suitable polymers, wood, composites and combinations thereof may be used. As noted, the body may have a central core (depicted as the entire body 102) which provides self flotation. Otherwise, reduced body mass allows less inertia, however, increased body mass may act as a flywheel and help to smooth out momentary irregularities in water flow.

Body 102 may have a length suitable for use in a given aqueduct, river, canal or the like. In particular, the length of the paddlewheel may be based upon the width of the aqueduct at the normal waterline or at the bottom.

Body 102 may have projecting therefrom a plurality of paddles such as paddle 104, which may be generally planar bodies or may be designed for hydrodynamic efficiency.

Paddlewheel axis 106 may be a physical axle as shown in other diagrams, or it may merely be an axis of rotation defined by the geometry and motion of the body 102 and paddles 104.

For clarity, paddle support 108 has been depicted to be transparent, however, it may not be. Paddle support 108 allows for greater strength of the paddles 104 with less overall mass, and is exemplary of various possible types of supports. For example, end support 108 may be replaced with a paddle support located at an intermediate position along the length of the paddlewheel. Various types of support structures may be used other than the circular ring shown in FIG. 1.

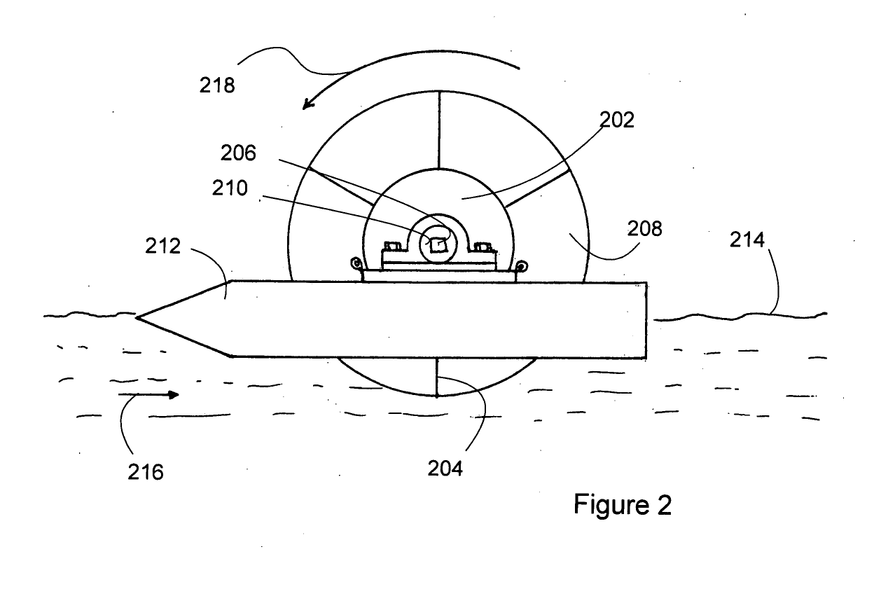

FIG. 2 is a partially transparent side view of a float and wheel portion of the first embodiment of the invention in use in a waterway.

Body 202 may be seen to be supported in a position with paddle 204 submerged wholly or partially, while other paddles are exposed to air. Paddlewheel axle 206 is seated in bearing and support assembly 210, and it may be seen that in this usage, the axis of the paddlewheel is actually above the level of the water: in other embodiments, the axis/axle (if used) may be submerged or sit at the surface of the water in alternatives which are not presently favored. The core portion 202 of the body may be seen to be partially submerged, but as with the axis, the design may be varied: the body may be entirely above the water level or may be submerged, etc.

Pontoon/float 212 may support the paddlewheel structure of the invention, in the best mode now contemplated, however, other embodiments may use floating paddle-wheel, or structures which hold the wheel in place in relation to the banks of the aqueduct/canal. Pontoon float 212 may advantageously be streamlined as shown.

Water/waterway 214 is seen to be deeper than the width of the depth of the water: one innovation of the present innovation is that the paddlewheel of the invention, instead of being optimized, may be arranged in a size and shape adapted to an aqueduct. Paddle support 208 and water 214 have been depicted to be transparent, however this is for the sake of clarity, water 214 and support 208 need not be transparent.

Flow direction arrow 216 shows the direction of flow of water in the waterway. The water flow pushes the submerged paddle 204, causing direction of paddlewheel rotation shown by arrow 218.

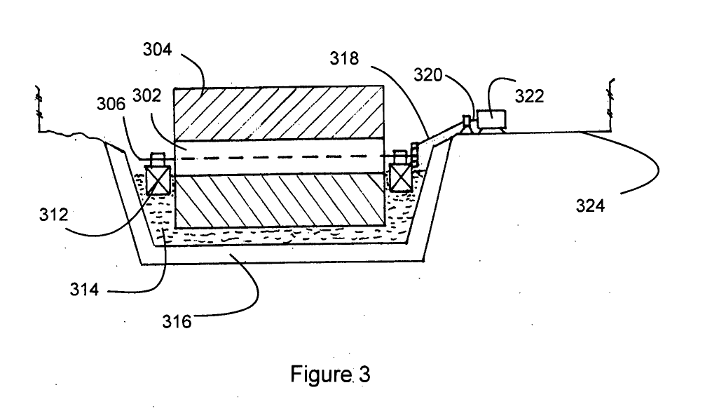

FIG. 3 is a cross-sectional end view of the first embodiment of the invention in use in a waterway, showing power transmission and electricity generation structures.

In the presently preferred embodiment and best mode presently contemplated for carrying out the invention, body 302 had paddle 304 submerged and being pushed by water flow, causing rotation of paddlewheel axle 306. Pontoon/float 312 supports the entire paddlewheel assembly on the surface of the water of waterway 314.

Aqueduct wall 316 may be seen to be of a relatively uniform character. This uniformity is important to the invention. One reason for the lack of use of energy device designs was the failure to design around the use of an aqueduct or canal: typical rivers vary considerably from point to point in terms of width, depth, suitable embankments and so on. Use of a paddlewheel energy device on a river frankly could necessitate specific construction of a short section of canal, dramatically increasing the cost of the installation. By designing a paddlewheel to the size of the canal or aqueduct, the aqueduct itself becomes an installed base for the device: the device, functions as a low cost addition to the cost of the aqueduct.

Rotary flexible power transmission 318 is important in allowing rotational mechanical energy transmission from the paddle wheel to the electrical generators on the bank. While flexible power transmission device 318 is shown attached to axle 306, it need not be. The flexible shaft device may be driven rack and pinion style by small gear teeth on the periphery of the paddle wheel or by other means, and thus is not limited to connection to the axle 306 only. Axle 306 may even be omitted in other embodiments.

The term flexible in this case refers not to a single flexible drive shaft which necessarily bends (though such devices may be used), but rather to the fact that the entire drive train allows for motion of the entire paddle wheel, for example, up and down as water levels change. Even if the individual components of the drive train are inflexible, the overall drive train may be flexible as defined herein if the overall drive train allows for power transmission despite differing water levels, or motion on the part of the paddle wheel, and so on.

Generator drive shaft 320 (which may include a flywheel as pictured) is then turned by the flexible drive device 318, causing electricity generator 322 to generate electricity.

Embankment/bank 324 as noted is normally ancillary to the aqueduct in any case, so while this component is used for the electricity generator, it is a fixed cost previously paid by most aqueduct or canal authorities.

If bank 324 does not support electrical generators, alternative embodiments of the device may be used which have the electrical generator placed on the paddlewheel structure itself. For example, the electrical generator 322 may be disposed on the pontoon 312 or even inside the core 302 of the paddlewheel body.

In alternative embodiments, the shape of the paddle may be made complementary to the cross sectional shape of the canal, for example, in FIG. 3, the canal has a cross sectional shape similar to a truncated triangle or prism: the paddle can easily be manufactured in a similar shape so as to increase efficiency.

Efficiency can be increased up to either practical limits or to the point that water flow is degraded by the paddles of the invention.

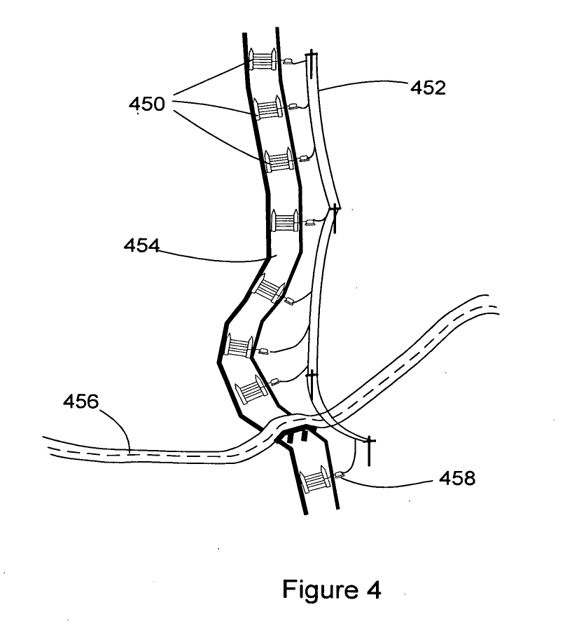

FIG. 4 is a planform top view of a section of aqueduct with multiple electrical energy generation devices of the invention shown in use.

Waterway 454 is shown from above, with a plurality of electricity generation devices 450 disposed afloat on the residential or agricultural water of the waterway. Electrical transmission system 452 is depicted as an above ground electrical wire but may be buried or may be any other type of electrical transmission system.

Waterway 454 will generally have interruptions 456 such as steep terrain, roads, bridges and so on. However, since the invention is a series of separate modules which can be positioned in any convenient manner, it is trivial to avoid interruptions and obstacles by merely omitting one or more units of the series of paddlewheel devices. The devices may also be omitted along stretches of an aqueduct which would not be economically feasible for power generation, or which are too far from a defined power demand area such as a city or the like. Note that electricity generated may be transmitted at any of a wide variety of voltages, frequencies and the like.

Electrical generator 458, one for each unit, may be seen to be depicted upon the bank of the aqueduct, but in practice may also be disposed on the pontoons, within the floating rotatable body or elsewhere as necessary or desirable.

Table One provides a single exemplary embodiment with dimensions of the device and the aqueduct for which it is designed. This particular design meets the size restrictions of the Central Arizona Project.

TABLE ONE

| | |
|---|---|
| Waterway width: | 56 feet (12 inch thick |
| | embankments) |
| Waterway min depth: | 16.5 feet |
| Waterway max depth: | 19.5 feet |
| Paddlewheel length: | 50 feet |
| Paddles: | 6 |
| Paddle length: | 15 feet |
| Paddle area: | 750 square feet per paddle |
| Potential power generation per unit: | 1.5 MW/hour |
| Separation distance between units: | approx. 170 feet |
| Units per mile: | 30 |
| Energy generation per mile: | 45 MW/hour |

### End Table One

This unit may be seen to potentially produce 45 megawatts of electricity from water motion which is already occurring. If three hundred miles of the CAP are usable at the separation distance of roughly 170 feet between units (more accurately 30 units per mile), then a total energy output of 1350 megawatts is possible. For comparison, in 2004, wind energy in the USA had a capacity of about 6,700 megawatts. However, the wind energy is a national figure, while the figure for the present invention is from one single three hundred mile long stretch of a single aqueduct, and there are many thousands of miles of aqueducts in the USA which are suitable for use with the invention.

A method embodiment of the invention is laid out in Table Two. The ordering of the steps of Table Two is merely exemplary, and can be varied.

TABLE TWO

| | |
|---|---|
| 1. | Disposing upon a section of aqueduct carrying slow moving agricultural or residential |
| | water, the section of aqueduct having a width and a depth and at least one bank, at least |
| | one rotatable floating body having an axis and a length, the rotatable floating body |
| | disposed afloat on such slow moving agricultural or residential water and disposed at |
| | least partially within such aqueduct, the rotatable floating body having a plurality of |
| | paddles projecting from the rotatable floating body orthogonal to the axis and projecting |
| | into the slow moving agricultural or residential water, the paddles having a width |
| | measured orthogonal to the axis and a length measured parallel to the axis, the body |
| | length and paddle length being less than such waterway width, the paddle width being |
| | less than such waterway depth. |
| 2. | Providing an electrical generator, the electrical generator having a generator shaft; |
| | providing a power transmission train having a first end connected to the rotatable floating |
| | body whereby the power transmission train rotates about the axis of the rotatable floating |
| | body when the rotatable floating body rotates, the power transmission train having a |
| | second end connected to the generator shaft and operatively connected thereto whereby |
| | motion of the slow moving agricultural or residential water impels rotation of the paddles |
| | and thus the rotatable floating body, and further whereby rotation of the rotatable floating |
| | body impels rotation of the power transmission train thereby impelling rotation of the |
| | electrical generator shaft. |
| 3. | Allowing the slow moving agricultural or residential water to rotate the rotatable floating |
| | body. |

### End Table Two

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims accompanying the corresponding utility application to be filed at a later date; the claims accompanying this application are not the broadest possible claim coverage.

I claim:

1. An electrical power generator comprising:
a section of aqueduct carrying slow moving agricultural or residential water, the section of aqueduct having a width and a depth and at least one bank;
a rotatable floating body having an axis and a length, the rotatable floating body disposed afloat on such slow moving agricultural or residential water and disposed at least partially within such aqueduct;
a plurality of paddles projecting from the rotatable floating body orthogonal to the axis and projecting into the slow moving agricultural or residential water, the paddles having a width measured orthogonal to the axis and a length measured parallel to the axis;
an electrical generator, the electrical generator having a generator shaft;
a power transmission train having a first end connected to the rotatable floating body whereby the power transmission train rotates about the axis of the rotatable floating body when the rotatable floating body rotates, the power transmission train having a second end connected to the generator shaft and operatively connected thereto whereby motion of the slow moving agricultural or residential water impels rotation of the paddles and thus the rotatable floating body, and further whereby rotation of the rotatable floating body impels rotation of the power transmission train thereby impelling rotation of the electrical generator shaft;
the body length and paddle length being less than such waterway width; and
the paddle width being less than such waterway depth.

2. The electrical power generator of claim 1, wherein:
the length of the paddles is approximately the width of the aqueduct.

3. The electrical power generator of claim 1, wherein:
the power transmission train is flexible.

4. The electrical power generator of claim 1, wherein:
the electrical generator is disposed upon the at least one bank of the aqueduct.

5. The electrical power generator of claim 1, further comprising:
a non-rotatable floating body part.

6. The electrical power generator of claim 5, wherein:
the electrical generator is disposed upon the non-rotatable floating body part.

7. The electrical power generator of claim 5, wherein the non-rotatable floating body part further comprises:
at least one pontoon disposed at a first end of the rotatable floating body.

8. A method of generating electrical power, the method comprising:
disposing upon a section of aqueduct carrying slow moving agricultural or residential water, the section of aqueduct having a width and a depth and at least one bank, at least one rotatable floating body having an axis and a length, the rotatable floating body disposed afloat on such slow moving agricultural or residential water and disposed at least partially within such aqueduct, the rotatable floating body having a plurality of paddles projecting from the rotatable floating body orthogonal to the axis and projecting into the slow moving agricultural or residential water, the paddles having a width measured orthogonal to the axis and a length measured parallel to the axis, the body length and paddle length being less than such waterway width, the paddle width being less than such waterway depth;
providing an electrical generator, the electrical generator having a generator shaft;
providing a power transmission train having a first end connected to the rotatable floating body whereby the power transmission train rotates about the axis of the rotatable floating body when the rotatable floating body rotates, the power transmission train having a second end connected to the generator shaft and operatively connected thereto whereby motion of the slow moving agricultural or residential water impels rotation of the paddles and thus the rotatable floating body, and further whereby rotation of the rotatable floating body impels rotation of the power transmission train thereby impelling rotation of the electrical generator shaft;
allowing the slow moving agricultural or residential water to rotate the rotatable floating body.

9. The method of generating electrical power of claim 8, wherein:
the length of the paddles is approximately the width of the aqueduct.

10. The method of generating electrical power of claim 8, wherein:
the power transmission train is flexible.

11. The method of generating electrical power of claim 8, wherein:
the electrical generator is disposed upon the at least one bank of the aqueduct.

12. The method of generating electrical power of claim 8, further comprising:
a non-rotatable floating body part.

13. The method of generating electrical power of claim 12, wherein:
the electrical generator is disposed upon the non-rotatable floating body part.

14. The method of generating electrical power of claim 12, wherein the non-rotatable floating body part further comprises:
at least one pontoon disposed at a first end of the rotatable floating body.

15. The method of generating electrical power of claim 8, wherein:
the electrical generator is disposed within the rotatable floating body.
